(19) United States
(12) Patent Application Publication
(10) Pub. No.: US 2004/0027375 A1
(43) Pub. Date: Feb. 12, 2004

(54) System for controlling a display of the user interface of a software application

(76) Inventors: Ricus Ellis, Pretoria (ZA); Andrew J. Fields, Pretoria (ZA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/311,039

(22) PCT Filed: Jun. 7, 2001
(86) PCT No.: PCT/IB01/01000

(30) Foreign Application Priority Data
Jun. 12, 2000 (ZA) 2000-2943
Aug. 7, 2000 (ZA) 200-4017

(51) Int. Cl. G09G 5/00

(52) U.S. Cl. 345/753

(57) ABSTRACT

This invention relates to a system (10) for controlling the display of a user interface of a software application. The system (10) includes an application server (14.1) for executing, upon request, at least one software application and display export means for exporting a user interface display of the at least one software application over a communications network. The system (10) also includes a client terminal (12.2) having a communication interface connected to the communication network, for receiving the user interface display, and a display means for displaying the user interface display. The system (10) also includes transfer means for transferring the user interface display from a first client terminal (12.2) to a second client terminal (12.3) without interrupting the operation of the at least one software application. The invention extends to a method of controlling the display of a user interface of a software application.

THIS INVENTION relates to a system for controlling the display of the user interface of a software application. The invention relates further to a method for controlling the display of a user interface of a software application and to a carrier medium carrying computer readable code for causing a computer to execute the method. The invention also relates to an application server and to a method of operating an application server and to a client device and to a method of operating a client device.

In general, desktop personal computing devices incorporate sufficient resources in the form of microprocessor performance and memory capacity in order to enable them to execute various complex software applications. However, due to space and cost constraints, small handheld and portable devices do not contain sufficient resources to execute these complex software applications. Thus, many small portable devices have customised diluted versions of regular software, which provide a user with only the basic functions of their parent products. Furthermore, documents and the like produced by these diluted applications need to be converted into a format suitable for a desktop machine, and similarly documents produced on desktop computers need to be converted for use on portable computers.

It is an object of the present invention to at least partially alleviate some of these problems.

According to one aspect of the invention, there is provided, a system for controlling the display of a user interface of a software application which includes

at least one application server for executing, upon request, at least one software application;

display export means for exporting a user interface display of the at least one software application over a communications network;

a first client terminal having a communications interface connected to the communications network, for receiving the user interface display, and having display means for displaying the user interface display; and

transfer means for transferring the user interface display from the first client terminal to at least a second client terminal without interrupting the operation of the at least one software application.

The system may include processor means for capturing a graphic image format of the user interface display and in which case the display export means may be configured to export the graphic image format of the user interface display and the communications interface of the client terminal may be configured to receive the graphic image format of the user interface display and to display the graphic image format of the user interface display on the display means.

The system therefore allows a simple computing device to use complex software without the need for the computing resources typically required for complex software applications. The resource requirements needed to run the application are implemented by the application server, and the client terminal merely serves as a display terminal.

According to another aspect of the invention, there is provided, a system for controlling the display of a user interface of a software application which includes

at least one application server for executing, upon request, at least one software application;

processor means for capturing a graphic image format of a user interface display of the at least one software application;

display export means for exporting the graphic image format of the user interface display over a communications network; and

a first client terminal having a communications interface connected to the communications network, for receiving the graphic image format of the user interface display, and having display means for displaying the graphic image format of the user interface display.

The system may include transfer means for transferring the graphic image format of the user interface display from the first client terminal to at least a second client terminal without interrupting the operation of the at least one software application.

The system thus allows a user to begin working on a particular application on the application server via a particular handheld or desktop computing device, and provides the. user with the ability to switch between different computing devices without having to interrupt the application. Thus, a user may interactively switch between a handheld device, used during transit, and a desktop machine used at a particular destination.

The client terminal may include user input means connected to the communications interface for allowing a user to request the application server to execute the or each software application and for allowing the user to interact with the or each software application via the graphic image format of the user interface display, said interaction facilitated via the communications interface.

Either the first or second client terminal may be configured to control the operation of the transfer means.

Instead or in addition, the application server may be configured to control the operation of the transfer means.

The system may include tracking means for tracking the relative positions of the first and second client terminal in which case the transfer means is configured to automatically transfer the graphic image format of the user interface display from the first client terminal to the second client terminal on the basis of the proximity between the first and second client terminal and the relative capability of each client terminal.

Thus, while in transit, a user may begin working on an application available on the application server, via a portable computing device, and as soon as the tracking means detects that the user has entered a designated location, in proximity to a computing device having increased display or interface capabilities, the system may automatically export the graphic format of the user interface display of the application to the more powerful computing device.

The system may further include application transfer means for transferring the or each software application from the first application server to at least a second application server.

The tracking means may be configured to monitor the position of the client terminal on which the graphic image format of the user interface display is currently displayed relative to the first and second application servers in which case the application transfer means may be configured to automatically transfer the software application from the first application server to the second application server, or vice versa, on the basis of proximity between said client terminal and the application servers.

The or each application server may include compression means for compressing the graphic image format of the user interface display before export to the or each client terminal.

The or each application server may include image formatting means for formatting the graphic image format of the user interface display before export to the or each client terminal, in-order to facilitate display on specific client terminal display means.

The processing means may includes comparator means for comparing the current user interface display of the software application with the most recently exported graphic image format of the user interface display and the processor means may be configured to capture a graphic image format of those regions of the user interface display which are different to the most recently exported graphic image format of the user interface display.

The or each application server may include storage means for storing the graphic image format of the user interface display before export to the or each client terminal. Thus, once the processor means has converted a particular user interface into a graphic format, it may store the graphic format before sending it to the or each client terminal.

The storage means may be configured to store user data. Thus, application and user data may be stored on the application server and will not be lost if the client terminal is corrupted, lost or damaged. In the event of the corruption, loss or damage of the client terminal, the user simply transfers to another client terminal, without interrupting the application, or losing any information.

The processing means may be configured to predict future user interface displays and preemptively capture a graphic image format of such predicted user interface displays and to store them in the storage means.

Typically, at least one of the client terminals is a portable or handheld device.

According to a further aspect of the invention, there is provided, a method of controlling the display of a user interface of a software application, the method including

executing at least one software application on at least a first application server;

rendering a graphic image format of a user interface display of the software application;

exporting the graphic image format of the user interface display to a first client terminal for display on the first client terminal; and

selectively transferring the graphic image format of the user interface display from the first client terminal to at least a second client terminal without interrupting the execution of the software application.

The method may further include

tracking the relative positions of the first and second client terminals; and

automatically transferring the graphic image format of the user interface display from the first client terminal to the second client terminal, or vice versa, on the basis of the proximity between the first and second client terminal and the relative capability of each client terminal.

The method may include

monitoring the relative distance between the client terminal on which the graphic image format of the user interface display is currently displayed and the first application server and a second application server; and

transferring the software application between the first and second application servers on the basis of the relative distance between said client terminal and the first and second application servers.

Instead, or in addition, the method may include

monitoring a rate of data transfer between the client terminal on which the graphic image format of the user interface display is currently displayed and the first application server and a second application server; and

transferring the software application between the first and second application servers on the basis of the relative rate of data transfer between said client terminal and the first and second application servers.

The method may further include the steps of

predicting a future user interface display of the or each software application;

rendering a graphic image format of the predicted user interface display; and

storing the graphic image format of the predicted user interface display for possible future export to the first or second client terminal.

The method may also include

comparing the current user interface display of the or each software application with the previous user interface display of the or each software application;

rendering a graphic image format of those regions of the user interface display which have changed; and

exporting the graphic image format of the changed regions of the user interface display to the first or second client terminal.

The method my include compressing the graphic image format of the user interface display before exporting the graphic image format of the user interface display.

The method may include formatting the graphic image format of the user interface display before exporting the graphic image format of the user interface display.

According to another aspect of the invention, there is provided a carrier medium carrying computer readable code for causing a computer to execute the method of controlling the user interface of a software application.

According to yet another aspect of the invention, there is provided an application server, which includes

storage means for storing at least one software application;

processor means for executing the at least one software application and for capturing a graphic image format of a user interface display of the at least one software application;

display export means for exporting the graphic image format of the user interface display to at least a first client terminal; and

transfer means for transferring the graphic image format of the user interface display to at least one further client terminal.

According to yet a further aspect of the invention, there is provided, a method of operating an application server which includes

executing at least one software application, stored on the application server, upon request from a first client terminal connected via a communications network to the application server;

rendering a graphic image format of a user interface display of the or each software application;

exporting the graphic image format of the user interface display, via the communications network, to the first client terminal for display on the first client terminal; and

selectively transferring the graphic image format of the user interface display from the first client terminal to at least a second client terminal without interrupting the execution of the or each software application.

The method may include transferring the graphic image format of the user interface display from the first client terminal to the second client terminal upon request from either of the client terminals.

The method may include

tracking the relative positions of the first and second client terminals; and

automatically transferring the graphic image format of the user interface display from the first client terminal to the second client terminal, or vice versa, on the basis of the proximity between the first and second client terminal and the relative capability of each client terminal.

The method may also include

monitoring the relative distance between the client terminal on which the graphic image format of the user interface display is currently displayed and the application server and at least a second application server; and

transferring the software application from the application server to the second application server on the basis of the relative distance between said client terminal and said application servers.

Instead, or in addition the method may further include

monitoring a rate of data transfer between the client terminal on which the graphic image format of the user interface display is currently displayed and the application server and at least a second application server; and

transferring the software application from the application server to the second application server on the basis of the relative rate of data transfer between said client terminal and said application servers.

The method may also include

predicting a future user interface display of the or each software application;

rendering a graphic image format of the predicted user interface display; and

storing the graphic image format of the predicted user interface display for possible future export to the first or second client terminal.

The method may further include

comparing the current user interface display of the or each software application with the previous user interface display of the or each software application;

rendering a graphic image format of those regions of the user interface display which have changed; and

exporting the graphic image format of the changed regions of the user interface display to the first or second client terminal.

The method may include compressing the graphic image format of the user interface display before exporting the graphic image format of the user interface display.

The method may also include formatting the graphic image format of the user interface display before exporting the graphic image format of the user interface display.

According to another aspect of the invention, there is provided, a carrier medium carrying computer readable code for causing a computer to operate in accordance with the method.

According to a further aspect of the invention, there is provided, a client device, which includes

a communication interface for communicating with an application server;

software application request means for requesting the application server to execute at least one software application;

display means for displaying a graphic image format of a user interface display of the or each software application exported to the client device by the application server via the communications interface;

user input means for allowing a user to interact with the or each software application via the graphic image format of the user interface display; and

transfer request means for requesting the transfer of the graphic image format of the user interface display to at least a second client device.

The communications interface, display means and user input means may all be configured to operate pre-boot up i.e. before the operating system has been loaded into memory. Thus, a user may switch on a computing device and automatically transfer the software application user interface display from one client to the new client without having to wait for the new client to boot up, thereby to save time.

According to a further aspect of the invention, there is provided a method of operating a client device, which includes

requesting an application server to execute at least one software application;

receiving a graphic image format version of a user interface display of the or each executed software application exported by the application server;

displaying the graphic image format version of the user interface display of the or each software application;

interacting with the or each executed software application via the graphic image format version of the user interface display of the or each executed software application; and

requesting the transfer of the graphic image format version of the user interface display of the or each software application to at least a second client device.

The method may further include storing graphic image format user interface displays spooled to the client device by the application server.

According to another aspect of the invention, there is provided a carrier medium carrying computer readable code for causing a client device to operate in accordance with the method.

The invention is now described, by way of example, with reference to the accompanying diagrammatic drawings.

In the drawings,

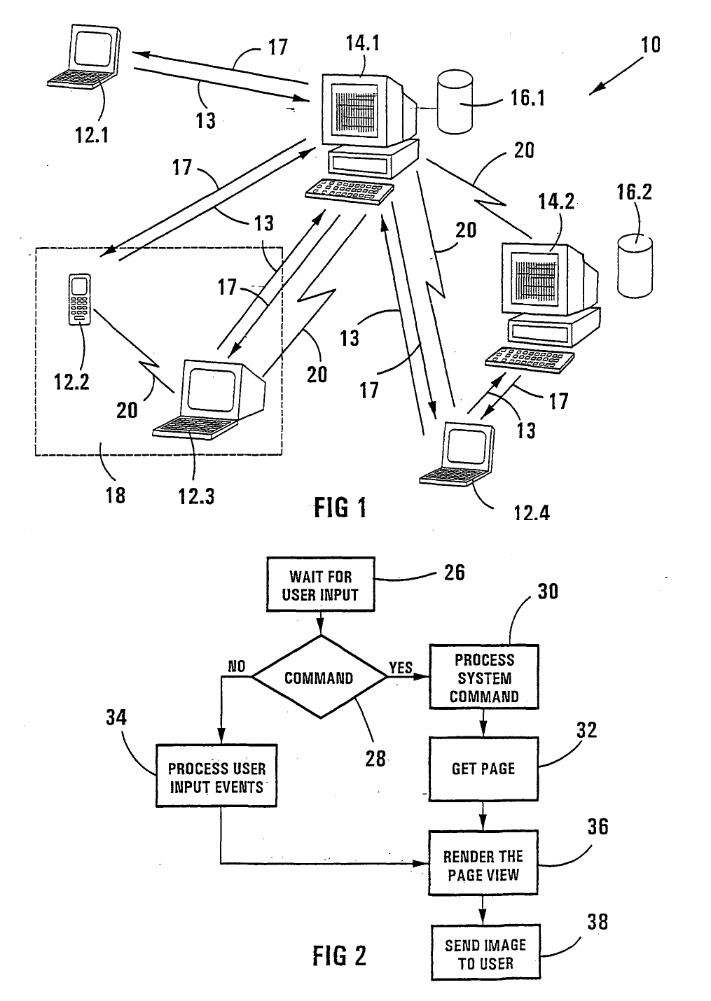

FIG. 1 shows a schematic block diagram of a system for controlling the display of a user interface of a software application, in accordance with the invention;

FIG. 2 shows a basic software flow chart of a computer program running on an application server, both in accordance with the invention;

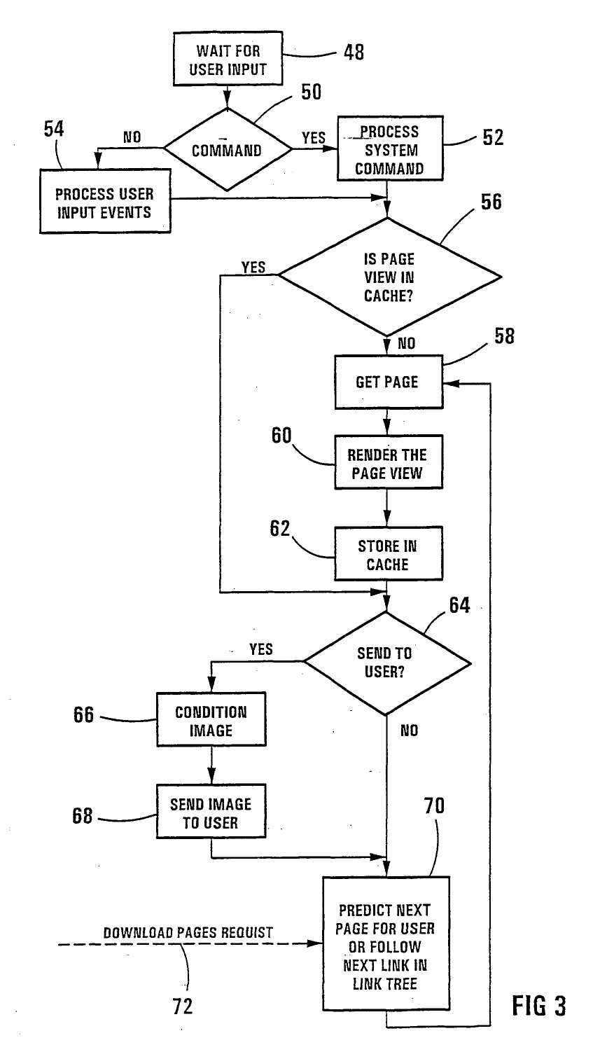

FIG. 3 shows a more detailed software flow chart of the computer program of FIG. 2 running on the application server;

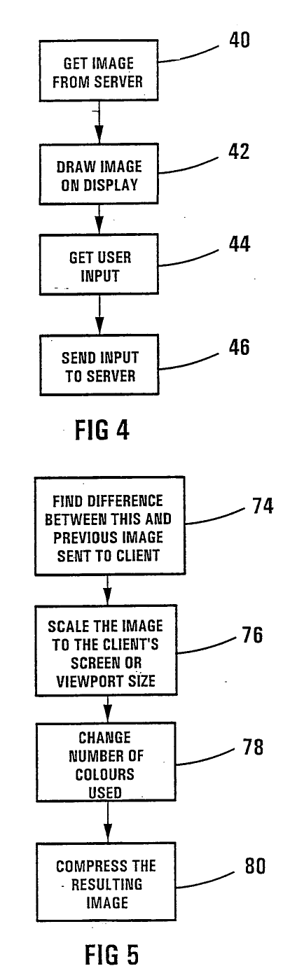

FIG. 4 shows a software flow chart of a computer program running on a client device, both in accordance with the invention; and

FIG. 5 shows a detailed software flow chart of an image conditioner.

Referring to the drawings, reference numeral 10 generally indicates a system for controlling the display of a user interface of a software application, in accordance with the invention. The system 10 includes a number of client devices or clients 12, such as PDA's (personal digital assistants), desktop computers, and the like. Each client 12 runs a software program, also in accordance with the invention that allows a user thereof to request an application server 14, also in accordance with the invention, to execute a particular software application, as indicated by reference numeral 13. These software applications are stored on the storage means 16 of the application server 14. The application server 14 then executes the requested software application, converts the user interface display of the software application into a graphic image format and transmits this graphic image format of the user interface display to the requesting client 12, as indicated by reference numeral 17. The client 12 then displays the graphic image format of the user interface display. A user of the client device 12, may then interact with the software application running on the application server 14, via the client device 12 via a user input means provided by the client 12. Thus, any commands the user inputs to the client device 12, are sent 13 to the server 14, which interprets the instructions and updates the software application user interface, re-renders a graphic image format version of the user interface, and sends 17 the updated image to the client 12. The system 10 may also transfer the graphic image format of the user interface from one client 12.2 to another 12.3 without interrupting the execution of the software application. This may be done interactively, at the request of either of the clients 12.2, 12.3 taking part in the transfer, or at the request of the server 14.1.

It is also possible for the system 10 to transfer the graphic image format of the user interface display of the software application automatically. In this case, if the system 10 detects, via a wireless communications link 20, that a client 12.2 has entered a designated area 18 in proximity to a client 12.3 having better display capabilities, the system 10 may automatically transfer the display from the client 12.2 to the client 12.3.

A user of a client 12 is thus able to execute a software application, off an application server 14, and transfer that application to other clients 12 as a user moves between different clients 12. This may be done at the request of the user, or automatically, when the system 10 detects that two clients, say 12.2 and 12.3 are in proximity to one another. It is to be appreciated that each client may be any electronic device which is capable of communicating with the server 14.1 and displaying information.

The two client devices 12.2, 12.3 are also configured to notify each other and the server 14 of the transfer of control. This notification of a change in display and input capabilities may occur automatically (via a wireless network, for example) or may be initiated by the user.

Thus, for example, if a user is browsing the world wide web on a mobile device like a PDA, and he arrives at his office where he has a PC or PC-Like workstation with superior screen display and user input capabilities, his mobile session will be automatically transferred to this workstation. Furthermore, as discussed, it is also possible for a user to request or initiate the transfer manually. Similarly, when the user leaves the office, he can transfer the browsing session or the application interface that he was running back to the PDA without losing data or interfering with the execution of the software application or the Internet connection.

Communication and data transmission between the client 12 and the server 14 is controlled by any of a variety of data communication protocols or interfaces, independent of the medium used for data transmission.

FIG. 2 shows a software flow chart of the computer program, in accordance with the invention, running on the application server 14. FIG. 2 shows the main tasks that one thread of the program will perform in response to input from a user interacting with the application server 14 via a networked client 12. A simple software flow chart indicating the software application operating the client device 12 is shown in FIG. 4.

With reference to FIG. 2 and FIG. 4, the following sequence of events occurs during a single thread of the program running on the application server 14. The thread begins by waiting for input from the user as indicated by block 26.

This input is typically sent to the server 14 by the client 12 in response to a command or instruction from the user of the client 12. Examples of typical user inputs may be requests for a new web page, a mouse click, a stylus touch to a touch sensitive screen or a keyboard input. These user inputs are interpreted at 44 and sent over the communications network, as indicated at 46, from the client 12 to the server 14.

The server 14 then decides, as shown at block 28, whether the user input is a specific command. If it is, then the server 14 processes the user command as indicated by block 30. An example of user commands may be to retrieve a new web page, quit from the application, or transfer the display and input options to another client device 12. For simplicity, the only command flow illustrated in this example is the “get new web page” command. Thus, for illustrative purposes, the example illustrates the system 10 when used for surfing the Internet on a client 12 via the application server 14. The command is processed at 32, and the requested new page is downloaded by the application server 14. This involves requesting the appropriate web page off the Internet and interpreting the HTML or other scripting language commands contained in the web page to generate the web page.

If the user has not entered a specific command then the client 12 has sent the server 14 a user event. User events are normally user inputs in the form of mouse moves and clicks or keyboard keystrokes. These are processed at 34 and a new page is similarly generated.

The new page or user interface display is then rendered at 36. This step converts the new page, which has been generated, at 32 or 34 into a graphic image format of the screen view or user interface display. This graphic image format of the user interface display is then sent over the network to the client 12 as indicated by block 38. The client 12 receives this image at 40 and displays the image as indicated at 42. If the graphic image format of the user interface display has been compressed, the client 12 uncompresses the graphic image format of the user interface display at 42. The user of the client 12 may therefore view and interact with Internet content without the client machine 12 having to interpret or render complicated page layouts. These tasks are left to the application server 14.

The user of the client 12 may also run other processor intensive software applications on the server 14, without the client 12 having to execute such processor intensive software applications. The application server 14 actually runs or executes these programs and only sends images to the client 12 in the form of graphic image format versions of the user interface display of such software applications. The client 12 provides the user with the ability to interact with this graphical format of the user interface display and the ability to send such instructions back to the server 14 to process, and does not have to run or process the applications itself.

A more detailed software flow chart of the computer program running. on the server 14 is shown in FIG. 3. This flow chart is similar to the flow chart of FIG. 2, except that a cache manager and image conditioning units have been included. The addition of the cache manager introduces most of the complexity to FIG. 4. The image conditioner is represented by a single block in FIG. 4, and further details of this image conditioner block are shown in FIG. 5.

The cache manager has two main functions. The first is to attempt to predict which page, or part of a page, or part of a user interface of a software application the user of the client 12 will request in future and to have graphic image formats of such pages ready for the-client 12 when or if they are requested. This improves the perceived speed of the client 12. Thus, in this case where the application run by the client 12 off the server 14 is an Internet web browser, the cache manager is configured to download and render pages associated with Internet links on the current page. In the case where the application executed is a wordprocessor or other application, the cache manager is configured to store subsequent pages of a working document. The second function of the cache manager emerges during autonomous operation, where it is used to download entire websites, render these pages into images and then store these images on disk or send them over a network to a client 12 for later use.

As shown in FIG. 3, the server thread can be initiated either by a user input request at 48, or by a list of page requests 72 being sent to the cache manager 70. If the input is from the user, the server 14 decides at 50 whether the input is a specific command, in which case it processes the command at 52. The processing of a command may involve the running of an application for the user. The command may also be a command to switch clients 12 as discussed below. If the user input is not a command, then the input is a user event which is processed at 54. in either case, the result will be a client 12 request for a new image, either based on a new page or a new view of the same page, modified by the user's input. The software decides at 56 whether it has already rendered this specific view. If it has, then it proceeds to step 64.

If it has not already rendered this view of the page, then the server 14 retrieves the page from the Internet, if necessary, or simply sends user input to the page as shown at 58. When the page has finished updating and processing the input from 58, the server 14 renders a view of the page at 60. The page is thus converted into a purely graphical format. This image is then stored in the cache 62 for possible future use.

The software then decides whether or not to send the page to the user at 64. This decision is based on whether the user requested the page that has just been rendered or whether the cache manager 70 requested the page. If the cache manager 70 requested the page, based on a prediction of the user's next page request, then the page may be stored locally or sent to the client 12, if the client has caching capabilities.

If the cache manager 70 requested the page from a download page request 72, then the page is not sent to the client 12 immediately, but rather left stored on disk or sent over a network for off-site storage. These pages may later be sent to a client device 12 having a storage facility. The user of the client 12 may therefore use the client 12 to perform offline browsing without necessarily being connected via a full-duplex link to the server 14.

If the server decides at 64 to send the image to the user, then it conditions the image at 66 prior to transmission. The steps performed at 66 are described in more detail below with reference to FIG. 5. If the cache manager requested the page from a download page request 72, the image conditioning steps performed in FIG. 5 are instead performed at 60. This separation maximizes the effectiveness of the caching algorithm. Once the image conditioning is complete, the image is sent to the client at 68, which performs the same task as block 38 in FIG. 2.

The cache manager 70 then predicts what the next page image is that the user will want or, if the cache manager 70 is downloading entire websites, then it downloads the next page or view of a page based on a requested list of links. In both cases, the cache manager 70 retrieves the page and loops back to step 58.

It is also important to note that the software is configured such that the user input at 48 may occur during any part of the flow chart, in which case the current process is interrupted, and the server thread is forced to go to step 48.

FIG. 5 shows the image conditioner module. The image conditioning module reduces the size of the graphical image sent to the client 12. Reducing the size of the image results in the image being transferred more quickly, thus, more images can be sent in the same amount of time. The module, also performs graphical manipulation on the image to match the image to the client 12 display parameters.

At step 74 the current graphic image format of the user interface display which is presently to be sent to the client 12 is compared with the previous graphic image format of the user interface display which was most recently sent to the client 12. This step finds the differences between the two images. If the difference between the images is minor, say for example, a small rectangular part of the screen has been changed, only the details in that rectangle are sent across to the client 12, with instructions on where the rectangle is to be placed on the screen. This step may also be performed after steps 76 and 78.

At step 76 the size of the image is altered to fit into the screen of the client 12. If the client 12 supports scrolling in a virtual window, larger in pixels than the actual screen size, then this step can scale the image to the virtual window size. This step may also intelligently scale fonts, tables, and graphics on the page to make the page legible and aesthetically pleasing to the eye when displayed on the client 12 display. Similar intelligent adjustments are also made to the number of colours in the picture at 78, as the display of the client 12 may not be able to display as many colours as the server 14 or the previous client 12 in the event of a transfer or handover between clients 12. The number of colours is typically reduced using dithering algorithms.

The image resulting from steps 74, 76 and 78 is then compressed using a standard image compression algorithm such as those specified by the Joint Photographic Experts Group (JPEG) or in the Portable Network Graphic (PNG) format as shown by block 80. This results in further reductions in the size of the image.

The steps performed by the server 14 described above will typically be run in multiple concurrently executing threads. This allows a single server 14 to service many clients 12 simultaneously.

The system 10 also allows a user to change clients 12 on the fly, i.e. without interrupting the operation or execution of a software application run by a client 12 off the server 14. A user can switch from one client device, say 12.2 to another 12.3 without losing any work, or restarting any machines. The command to transfer or redirect the graphic. image format of the user interface display may come from either of the clients 12.2, 12.3, the server 14, or another machine on the network. This command tells the server 14 to redirect the display and user input from the current client 12.2 to the client 12.3. The clients 12.2, 12.3 are also notified of this command. Security and authentication processes are then used to prevent clients 12 and servers 14 being transferred by servers 14 or clients 12 without the proper credentials.

This transfer or redirect command may be issued by the user of the client device 12.2, instructing the client 12.2 to transfer control to another client 12.3, or by requesting a client 12.3 to assume control of the user interface currently displayed on another client 12.2. The redirect command may also be issued automatically. In this case, the user may roam around and have the graphic image format of software application display transferred to the best available client 12. In the embodiment depicted in the drawings, the system 10 monitors the proximity between clients 12, via a wireless communications link 20 between the clients 12 and servers 14, and automatically transfers the graphic image format of the user interface between clients 12, on the basis of the proximity and the relative capabilities of each client 12.

The system 10 is also configured to enable an application to be transferred or redirected from one server 14.1 to another server 14.2. Thus, an application being run by a user may be switched between different application servers 14.1 and 14.2. This can be done manually or automatically, and the authentication and redirection commands involved are similar to that of client 12 switching.

In an environment where there are multiple servers available e.g. servers 14.1 and 14.2, either a client 12 or a server 14 can request that a client 12 be transferred from one server 14.1 to another 14.2. This is also handled simply as a command by the server 14, in the normal command loop. When the server 14.1 receives this command, it notifies the client, 12.4 in FIG. 1, of the details of the new server 14.2, it saves the structures and data for this client 12.4, and sends them to the other server 14.2. The new server 14.2 then loads the structures and data for the client 12.4 and continues operation. The software application run by the client 12 is thus switched between the servers 14.1 and 14.2 without interfering with the operation of the application from the client's point of view.

Further features of the invention will emerge in the course of the following discussion of a number of examples of applications of the invention.

A PDA (personal digital assistant) is typically a small handheld, battery operated computer. Current examples are the popular PalmPilot™ series made by 3Com™ corporation, and various Windows™ CE™ (now known as PocketPC™) compatible devices like the Casio™ Cassiopeia™ and the Hewlett Packard™ Journada™.

These devices typically take input from the user by making the user tap a stylus on the screen. Most also have handwriting recognition software which allows for text entry. The screen area is typically in the range of 160 by 160 pixels for the PalmPilot™ family of devices, and 320 by 240 pixels for the Windows™ CE™ family. The number of colours per pixel range from 8 shades of grey to about 216 colours. PDA's can connect to other computers using standard modems, direct connections, Ethernet or wireless modems.

In this context, a user of a PDA will run a client application, which connects to the server 14 over a wireless modem. The server 14 then authenticates the user, and sends the user his or her default page or send a welcome page. The user then selects a page on the web that he or she wishes to view. The PDA will then send this page request to the server 14. The server 14 will retrieve this page from the Internet or the server 14 cache. The server 14 will then convert this page into a graphic format suitable for the particular PDA and this graphical image format of the user interface display will be sent to the PDA, which will display it on its screen. Further details relating to this conversion are described below.

Two main classes of steps are followed by the server 14 in order to format or condition the web page for the PDA prior to transmission. These steps are the pre-processing of the page layout and the pixel based graphical manipulation.

Before the web page is rendered into a graphic image format, the page may undergo pre-processing. A number of possible pre-processing routines are then preformed.

Firstly, style sheets are applied to change the look of the page to make the fonts, images, tables, buttons and frames scale correctly. For example, the pitch size of the fonts may be increased, as the screen of the PDA is typically smaller than that of the server 14.

Secondly, Java scripts, Java applets, DHTML, ActiveX content and other scripting instructions may be executed on the server side to format the look of the page.

Furthermore, certain elements may be removed altogether or put on higher level pages. Thus, for example, frame-based pages may be split into multiple pages. A separate page can be created for each frame. For example, if the content is a web page with a frame on the left hand side of the page which acts as an index for the user to retrieve pages on the site, then this page will be used as a higher level page. Clicking on links on this higher level page will result in the PDA opening full new pages. The user will then use the “back” button to go back to the index page.

In addition animated pictures (such as banner advertisements) can be turned into static pictures. Furthermore, background graphics can be removed, and other pictures and buttons can be rescaled.

The graphical manipulation step, which follows the pre-processing entails converting the web page into an image. Much of what happens in this step is determined by how much has changed on the page, compared to the last page sent, as discussed above with reference to FIG. 5.

If the user has performed an action which only causes a small area of the screen to change, for example, pulling down a drop-down menu box, then only the screen area that has changed, in this case, the drop down menu, is converted into a graphic image and sent across the network. Thus, only the differences between sequential pages are transmitted to the client 12, thereby reducing bandwidth requirements. If the user has performed an action which results. in a complete new page, then the entire page is sent to the client 12. The page is then scaled, colour reduced and compressed as shown in FIG. 5.

In an example where a PalmPilot™ PDA with a 160 by 160 pixel display with 16 shades of grey available for each pixel, the following would occur. Firstly, the difference between the current image and the previous image sent to the client device 12 is determined as discussed above. If only minor changes have occurred, then an image containing only these minor changes is created to be sent, which may be only a small part of the total screen area, as in the case of a drop-down menu box. Secondly, the number of colours used in the image is reduced from 24 bits per pixel (8 each for red, green and blue) typically used in web graphics, to 16 shades of grey (4 bits per pixel). Image dithering and sharpening algorithms are used in this step to ensure that the resulting image is aesthetically pleasing to the eye. The image is then scaled from its original size to the available 160 by 160 pixels. Once again image dithering, posterising and sharpening algorithms are used to keep the image quality acceptable. The image is then compressed using an image compression algorithm. This compressed and formatted image is then sent over the network to the client 12 PDA.

Upon receiving the above image, the PDA or client 12 will uncompress the image and display it. The PDA may either be configured to wait for the entire image to arrive before displaying it, or it may build up the image line by line or region by region as data arrives. The PDA then waits for user instructions, e.g. a click on a link, entered data, a page scroll, or any other user action.

If these actions result in a request for a new page, or an update of the image currently displayed on the PDA screen, these commands are sent to the server 14 and a new page is rendered and sent to the PDA as discussed above.

The cache manager may also be considered in the above example. The cache is stored in two physical locations. The cache on the server 14 which stores all the pages and images that pass through it, and a much smaller image cache on the PDA device or client 12, which can store a limited number of images.

When the user of the PDA performs an action which results in a different view of a page being required, the PDA first checks to see if it has an image representing this page in its local memory. If it has, then it will display it. This typically occurs when the PDA is displaying page A, the user goes to page B, and then hits the back button on the browser and returns to page A. The PDA cache will then reload page A immediately instead of retrieving it from the server 14.

While the user of the PDA is viewing a page, the server 14 can spool other page images to the PDA. These page images are based on predictions of what the user will do next. One example of such a predication may be that the user hits the page down key, which results in a view of the page below the current page being streamed to the PDA. Another example is to follow the first link on the current page and stream the image of this to the PDA's cache, or store it locally.

The main purpose of the cache manager is to try and make the user's next web page as readily available as possible, thereby to minimize the time spent waiting for pages to arrive.

A further example of the capability of the system 10 is illustrated in the context of pre-boot up web browsing or operation and thin-client web browsing. Pre-boot up web browsing involves browsing the web on a regular PC (personal computer), just after the PC has been turned on, at the stage before the operating system has been loaded. Thin-client web browsing involves web browsing on a “thin” PC-type device having minimal hardware and a limited operating system.

In both cases a lot of the functionality provided by the operating system (such as Windows™ 95) and web browser program (such as Internet Explorer™) on typical PC platforms is provided by the server 14. In the case of pre-boot up operation, the client 12 provides networking software, mouse and cursor support software and screen graphics software. Typical hardware in this configuration consists of a standard PC with network connectivity provided by either a network card or a modem.

The operation of such a device will be similar to that of the PDA described above except that the network transport may be faster than that of the PDA, which may allow larger pages to be sent across, and typically more pages may be cached on the larger memory available on the standard PC client 12. Furthermore, the screen resolution and colour depth available will be much better than that available to PDA's and thus less resizing and dithering is required.

Thus, the user is able to browse the web without the overhead of waiting for the PC to start up and the operating system to load. The moment the PC powers up, and the network is activated, the client 12 can be used to browse the web.

If a user is running some other type of software application, other than a web browser, such as a wordprocessor, spreadsheet, database, e-mail or scheduling program, pre boot-up operation will allow the user to turn on the client 12 and have his application, desktop and data restored almost immediately, as all of the data and state variables are stored on the server 14. He can also turn off the device whenever he wishes without having to worry about data loss. Furthermore, the data security and storage is handled centrally by the server 14, and the user does not need to concern himself with viruses or data backup. The user can thus roam around, and have the same desktop and applications on whichever device 12 he or she logs into.

In addition if a client device 12.3 fails a user can log into the server 14, from another client device 12.2 and continue working, while waiting for a support team to fix the client device 12.3.

In the case of thin-client browsing, the client 12 typically consists of a large storage device (typically a hard disk drive), a high bandwidth down-link (typically a satellite receiver), a television set to display the page, a small processor and a TV display card.

The user will then specify which websites or parts of websites he or she is interested in subscribing to. The server 14 will convert these pages into images suitable for viewing on a television. These images will be spooled down via the high bandwidth link from the server 14 to the client 12, and stored on the client's hard disk together with an index to the pages.

When the user wishes, he or she can browse through the pages very quickly as they are stored locally on the client 12 and do not need to be downloaded. If the user wishes, he or she can dial up back to an ISP and interact with the pages, however if the user just wishes to view the pages this is not necessary.

The server 14 may also insert its own advertising graphics onto the images before spooling them down to the client 12. This service provides very quick access to a few thousand web pages.

Examples of the redirection or transfer capabilities of the system 10 are now discussed. During a user's commute to work, the user works on the client 12.2 which is a PDA, connecting to either the Internet or running applications on a server 14 as described above.

When the user arrives at the office, the user can switch the display and input to the client 12.3 which is a PC. This can either be done automatically or may be initiated by the user, by instructing either the PDA 12.2 or the PC 12.3 to transfer or redirect the user interface display.

The transfer need not only occur between a PC 12.3 and a PDA 12.2. It is also possible to transfer control between one PC and another, or between a PC 12.3 and a cell phone, or between a cell phone and a PDA 12.2 or between any other two computing devices. Furthermore, the PC 12.3 may be a desktop type workstation running Windows™ or Unix™, or a dumb terminal, or some other desktop PC-like device.

The user can initiate the switchover or transfer from the original client (in this case, the PDA 12.2) or he can instruct the new client (in this case, the PC 12.3) to take over from the original client 12.2.

In the case of the user instructing the PDA 12.2 to switch to the PC display 12.3 and input controls, the user selects a menu option on the PDA 12.2, which sends a command to the server 14.1, instructing it to switch display and input services to the user's desktop PC 12.3. The server 14.1 is then configured to check to see if the desktop PC. 12.3 is available and retrieve hardware information from the PC 12.3, such as screen size, available input devices and network capabilities. The server 14.1 will also authenticate the user on the PC 12.3 and the client 12.2, to check whether the user is allowed to use the PC 12.3, and if the PDA 12.2 is allowed to transfer control. During the transfer, if required, the server 14.1 may also hand over control to another server 14.2 having a faster connection to the PC.

The user may also initiate the transfer from the PDA 12.2 to the PC 12.3 via the PC 12.3. This is done by sending a command either to the server 14.1, or to the PDA 12.2, from the PC 12.3. This command will transfer control to the PC 12.3. Similar command flow to that described above will occur.

Thus, the user can transfer his working environment from the PDA 12.2 to the PC 12.3 almost instantaneously, and continue working on the same data or viewing the same web page without interruption. The data that the user is working on, as well as the applications themselves are run and stored on the server 14. Thus, the user does not need to be concerned with data backup or preventing data loss as this is all handled by the server 14.

When the user decides to leave the office he can also transfer his work environment back to the PDA 12.2. As described above, the instruction to transfer may come either from the PC 12.3 or the PDA 12.2. Authentication, command switching, new device capability settings and possible server switching are then handled as described above.

The graphic image format of the user interface may also be transferred between clients 12 automatically. Automatic transfer differs from manual transfer only in that the origin of the redirect or transfer command differs. With automatic redirection, the user no longer sends a redirect command as it is issued automatically by the system 10.

Automatic transfer or switchover allows the user to roam freely and have the best possible display device automatically selected. In a typical example of automatic transfer, the user may arrive at an office after working on a PDA 12.2 while in transit, and as soon as the user enters the office, the display and input devices are automatically switched from the PDA 12.2 to the PC 12.3. This switchover may be handled over a wireless communication link 20 or by direct physical connection, for example, via a docking station. If the user leaves the office with the PDA 12.2, the display and input are automatically restored to the PDA 12.2 environment.

The wireless communication link 20 between the PDA 12.2 and the PC 12.3, or between the PDA 12.2, and a locator device in the building, and the server 14 is normally in the form of infrared communication or RF communication using roaming protocols like Bluetooth, or cellular protocols such as GSM.

In the case where both the PDA 12.2 and the PC 12.3 have low range RF communication interfaces, the PC 12.3 is configured to detect the proximity of the PDA 12.2 and to send a command to the PDA 12.2 via the server 14.1 asking it to transfer control. If the server 14.1 approves of this transfer, then the PDA 12.2 informs the server 14.1 that the PC 12.3 is now the new display and input device, and transfer and security are handled as described above.

In the case where the PDA 12.2 or the user of the PDA 12.2 has a locator device, from which the server 14.1 can determine the PDA's 12.2 or the user's location in a building, the server 14.1 is configured to initiate the command transfer automatically, thus moving control from the PDA 12.2 to the PC 12.3 or workstation closest to the user.

The roaming technologies described above allow the user freedom from specific workstations or PDA's 12.2 and allow the data and applications used by the user to follow the user without the user interrupting his work session. It is also possible to transfer seamlessly to a cheaper or alternative connection without interference.

As discussed above, the system 10 also allows a client 12 to request to. be transferred to another server 14 based on the proximity to a particular server 14. 1, 14.2. Typically, the closest server 14.1, 14.2 to the client 12 would provide the fastest connection.

The client 12 can also switch servers 14 when, for example, a user arrives with a PDA client 12.4 at an office which has its own local (probably LAN based) server 14.1. When the PDA client 12.4 switches to the PC client 12.3, the mobile server 14.2 can also transfer the or each software application to a local server 14.1 on the same local area network as the PC 12.3. This would allow for faster and cheaper server access for the PC client 12.3. When the user leaves the office, the PC 12.3 can switch clients to the PDA 12.2, while the local LAN server 14.1 can also switch to a more central wireless based server 14.2.

As discussed above, the server 14.1 may also switch a client 12 to another server 14.2, which is faster, automatically. Another use for server switching or transferring would be in an office environment where a cluster of servers 14 could move clients 12 between them in order to share or balance server 14 loads.

The Applicants believe that the invention, as illustrated, provides a relatively simple system 10 for controlling the display of a user interface of a software application. The system 10 allows a client device 12 in the form of a simple handheld or portable device to run complex software off an application server 14. The application server 14 executes the software and renders a graphic image format version of the user interface display, which is then transmitted to the client device 12. The client device 12 merely acts as a display and input device and all processing and data storage is handled by the application server 14. Thus, simple computing devices are able to run complex software, typically developed to run on high end desktop machines. Thus, separate applications are no longer required for portable device and desktop devices, which eliminates the need to transfer documents having different formats between handheld and desktop computers, which is often time consuming and clumsy. Furthermore, a user no longer needs to learn how to use two different applications.

The system 10 also enables a user to seamlessly transfer his computing environment, including any number of applications, from one client 12 to another, without interrupting the execution of the applications, and without the risk of losing or corrupting data. All data and applications are run form the server 14 and a user can therefore switch his portable or other computing device on and off and resume working where he or she left off. A user can also simply switch between devices 12, depending on the requirements and circumstances of the user. Furthermore, as the system operates off a network and is connectable to the internet, a user can roam freely around the world, and log into his computing environment without having to risk the chance of losing information or data.

The central storage of applications and data, also ensures robustness and maintainability of the system. For example the system 10 may be less as vulnerable to viruses as the entire system is controlled form a central location. Furthermore, a user does not have to continually upgrade his personal computing device or software as this is all handled centrally.

1. A system for controlling the display of a user interface of a software application which includes
at least one application server for executing, upon request at least one software application;
display export means for exporting a user interface display of the at least one software application over a communications network;
a first client terminal having a communications interface connected to the communications network, for receiving the user interface display, and having display means for displaying the user interface display; and
transfer means for transferring the user interface display from the first client terminal to at least a second client terminal without interrupting the operation of the at least one software application.

2. A system as claimed in claim 1, which includes processor means for capturing a graphic image format of the user interface display and in which the display export means is configured to export the graphic image format of the user interface display and in which the communications interface of the client terminal is configured to receive the graphic image format of the user interface display and to display the graphic image format of the user interface display on the display means.

3. A system for controlling the display of a user interface of a software application which includes
at least one application server for executing, upon request, at least one software application;
processor means for capturing a graphic image format of a user interface display of the at least one software application;
display export means for exporting the graphic image format of the user interface display over a communications network;
a first client terminal having a communications interface connected to the communications network, for receiving the graphic image format of the user interface display, and having display means for displaying the graphic image format of the user interface display; and
transfer means for transferring the graphic image format of the user interface display from the first client terminal to at least a second client terminal without interrupting the operation of the at least one software application.

4. A system as claimed in claim 3, in which the client terminal includes user input means connected to the communications interface for allowing a user to request the application server to execute the or each software application and for allowing the user to interact with the or each software application via the graphic image format of the user interface display, said interaction facilitated via the communications interface.

5. A system as claimed in claim 3 or claim 4, in which either the first or second client terminal is configured to control the operation of the transfer means.

6. A system as claimed in claim 3 or claim 4, in which the application server is configured to control the operation of the transfer means.

7. A system as claimed in any one of the preceding claims 3 to 6 inclusive, which includes tracking means for tracking the relative positions of the first and second client terminal and in which the transfer means is configured to automatically transfer the graphic image format of the user interface display from the first client terminal to the second client terminal on the basis of the proximity between the first and second client terminal and the relative capability of each client terminal.

8. A system as claimed in claim 7, which includes application transfer means for transferring the or each software application from the first application server to at least a second application server.

9. A system as claimed in claim 8, in which the tracking means is configured to monitor the position of the client terminal on which the graphic image format of the user interface display is currently displayed relative to the first and second application servers and in which the application transfer means is configured to automatically transfer the software application from the first application server to the second application server, or vice versa, on the basis of proximity between said client terminal and the application servers.

10. A system as claimed in any one of the preceding claims 3 to 9 inclusive, in which the or each application server includes compression means for compressing the graphic image format of the user interface display before export to the or each client terminal.

11. A system as claimed in any one of the preceding claims 3 to 10 inclusive, in which the or each application server includes image formatting means for formatting the graphic image format of the user interface display before export to the or each client terminal, in order to facilitate display on specific client terminal display means.

12. A system as claimed in any one of the preceding claims 3 to 11 inclusive, in which the processing means includes comparator means for comparing the current user interface display of the software application with the most recently exported graphic image format of the user interface display and in which the processor means is configured to capture a graphic image format of those regions of the user interface display which are different to the most recently exported graphic image format of the user interface display.

13. A system as claimed in any one of the preceding claims 4 to 13 inclusive, in which the or each application server includes storage means for storing the graphic image format of the user interface display before export to the or each client terminal.

14. A system as claimed. in claim 13, in which the storage means is configured to store user data.

15. A system as claimed in claim 14, in which the processing means is configured to predict future user interface displays and preemptively capture a graphic image format of such predicted user interface displays and to store them in the storage means.

16. A system as claimed in any one of the preceding claims, in which at least one of the client terminals is a portable or handheld device.

17. A method of controlling the display of a user interface of a software application, the method including
executing at least one software application on at least a first application server;
rendering a graphic image format of a user interface display of the software application;
exporting the graphic image format of the user interface display to a first client terminal for display on the first client terminal; and
selectively transferring the graphic image format of the user interface display from the first client terminal to at least a second client terminal without interrupting the execution of the software application.

18. A method as claimed in claim 17, which includes
tracking the relative positions of the first and second client terminals; and
automatically transferring the graphic image format of the user interface display from the first client terminal to the second client terminal, or vice versa, on the basis of the proximity between the first and second client terminal and the relative capability of each client terminal.

19. A method as claimed in claim 17 or claim 18, which includes
monitoring the relative distance between the client terminal on which the graphic image format of the user interface display is currently displayed and the first application server and a second application server; and
transferring the software application between the first and second application servers on the basis of the relative distance between said client terminal and the first and second application servers.

20. A method as claimed in claim 17 or claim 18, which includes
monitoring a rate of data transfer between the client terminal on which the graphic image format of the user interface display is currently displayed and the first application server and a second application server; and
transferring the software application between the first and second application servers on the basis of the relative rate of data transfer between said client terminal and the first and second application servers.

21. A method as claimed in any one of the preceding claims 17 to 20 inclusive, which includes
predicting a future user interface display of the or each software application;
rendering a graphic image format of the predicted user interface display; and
storing the graphic image format of the predicted user interface display for possible future export to the first or second client terminal.

22. A method as claimed in any one of the preceding claims 17 to 21 inclusive, which includes
comparing the current user interface display of the or each software application with the previous user interface display of the or each software application;
rendering a graphic image format of those regions of the user interface display which have changed; and
exporting the graphic image format of the changed regions of the user interface display to the first or second client terminal.

23. A method as claimed in any one of the preceding claims 17 to 22 inclusive, which includes compressing the graphic image format of the user interface display before exporting the graphic image format of the user interface display.

24. A method as claimed in any one of the preceding claims 17 to 23 inclusive, which includes formatting the graphic image format of the user interface display before exporting the graphic image format of the user interface display.

25. A carrier medium carrying computer readable code for causing a computer to execute the method as claimed in any one of the preceding claims 17 to 24 inclusive.

26. An application server, which includes
storage means for storing at least one software application;
processor means for executing the at least one software application and for capturing a graphic image format of a user interface display of the at least one software application;
display exports means for exporting the graphic image format of the user interface display to at least a first client terminal; and
transfer means for transferring the graphic image format of the user interface display to at least one further client terminal, without interrupting the operation of th at least one software application.

27. A method of operating an application server which includes
executing at least one software application, stored on the application server, upon request from a first client terminal connected via a communications network to the application server;
rendering a graphic image format of a user interface display of the or each software application;
exporting the graphic image format of the user interface display, via the communications network, to the first client terminal for display on the first client terminal; and
selectively transferring the graphic image format of the user interface display from the first client terminal to at least a second client terminal without interrupting the execution of the or each software application.

28. A method as claimed in claim Z7, which includes
transferring the graphic image format of the user interface display from the first client terminal to the second client terminal upon request from either of the client terminals.

29. A method as claimed in claim 27 or claim 28 which includes
tracking the relative positions of the first and second client terminals; and
automatically transferring the graphic image format of the user interface display from the first client terminal to the second client terminal, or vice versa, on the basis of the proximity between the first and second client terminal and the relative capability of each client terminal.

30. A method as claimed in any one of the preceding claims 27 to 29 inclusive, which includes
monitoring the relative distance between the client terminal on which the graphic image format of the user interface display is currently displayed and the application server and at least a second application server; and
transferring the software application from the application server to the second application server on the basis of the relative distance between said client terminal and said application servers.

31. A method as claimed in any one of the preceding claims 27 to 29 inclusive, which includes
monitoring a rate of data transfer between the client terminal on which the graphic image format of the user interface display is currently displayed and the application server and at least a second application server; and
transferring the software application from the application server to the second application server on the basis of the relative rate of data transfer between said client terminal and said application servers.

32. A method as claimed in any one of the preceding claims 27 to 31 inclusive, which includes
predicting a future user interface display of the or each software application;
rendering a graphic image format of the predicted user interface display; and
storing the graphic image format of the predicted user interface display for possible future export to The first or second client terminal.

33. A method as claimed in any one of the preceding claims 27 to 32 inclusive, which includes
comparing the current user interface display of the or each software application with the previous user interface display of the or each software application;
rendering a graphic image format of those regions of the user interface display which have changed: and
exporting the graphic image format of the changed regions of the user interface display to the first or second client terminal.

34. A method as claimed in any one of the preceding claims 27 to 33 inclusive, which includes compressing the graphic image format of the user interface display before exporting the graphic image format of the user interface display.

35. A method as claimed in any one of the preceding claims 27 to 33 inclusive, which includes formatting the graphic image format of the user interface display before exporting the graphic image format of the user interface display.

36. A carrier medium carrying computer readable code for causing a computer to execute the method as claimed in any one of the preceding claims 27 to inclusive.

37. A client device, which includes
a communication interface for communicating with an application server;
software application request means for requesting the application server to execute at least one software application;
display means for displaying a graphic image format of a user interface display of the or each software application exported to the client device by the application server via the communications interface;
user input means for allowing a user to interact with the or each software application via the graphic image format of the user interface display; and
transfer request means for requesting the transfer of the graphic image format of the user interface display to at least a second client device.

38. A client device as claimed in claim 37, in which the communications interface, the display means and the user input means are all configured to operate pre-boot up.

39. A method of operating a client device, which includes
requesting an application server to execute at least one software application;
receiving a graphic image format version of a user interface display of the or each executed software application exported by the application server;
displaying the graphic image format version of the user interface display of the or each software application;
interacting with the or each executed software application via the graphic image format version of the user interface display of the or each executed software application; and
requesting the transfer of the graphic image format version of the user interface display of the or each software application to at least a second client device.

40. A method as claimed in claim 39, which further includes storing graphic image format user interface displays spooled to the client device by the application server.

41. A carrier medium carrying computer readable code for causing a client device to execute the method as claimed in claim 39 or claim 40.

42. A system as claimed in claim 1, substantially as herein described and illustrated.

43. A method as claimed in claim 17, substantially as herein described and illustrated.

44. An application server as claimed in claim 26, substantially as herein described and illustrated.

45. A method of operating an application server as claimed in claim 27, substantially as herein described and illustrated.

46. A client device as claimed in claim 37, substantially as herein described and illustrated.

47. A method of operating a client device as claimed in claim 39, substantially as herein described and illustrated.

48. A new system for controlling the display of the user interface of a software application, a new method of controlling the display of the user interface of a software application, a new application server, a new method of ope rating an application server, a new client device, or a new method of operating a client device, substantially as herein described.
